(19) United States
(12) Patent Application Publication
(10) Pub. No.: US 2021/0360223 A1
(43) Pub. Date: Nov. 18, 2021

(54) DISPLAY DEVICES INCLUDING SWITCHES FOR SIMULTANEOUSLY TRANSMITTING IDENTICAL PIXEL DATA TO FIRST AND SECOND DISPLAY REGIONS

(71) Applicant: Hewlett-Packard Development Company, L.P., Spring, TX (US)

(72) Inventor: Lee Atkinson, Taipei City (TW)

(73) Assignee: Hewlett-Packard Development Company, L.P., Spring, TX (US)

(21) Appl. No.: 16/978,242

(22) PCT Filed: Apr. 24, 2018
(86) PCT No.: PCT/US2018/029018

§ 371 Date: Sep. 4, 2020

(51) Int. Cl. H04N 13/344; G02B 27/01; G06F 3/14; H04N 13/106

(52) U.S. Cl. CPC H04N 13/344; H04N 13/106; G06F 3/1423; G02B 27/017

(57) ABSTRACT

A display device includes a first plurality of pixels, a second plurality of pixels, a first serial-to-parallel converter (SPC), a second SPC, a timing controller, and a switch. The first plurality of pixels forms a first display region to display a first image to be viewed by a user's left eye. The second plurality of pixels forms a second display region to display, simultaneously with display of the first image, a second image to be viewed by the user's right eye. The first SPC is coupled to the first display region; the second SPC is coupled to the second display region. The timing controller detects an indicator in a signal received from a graphics controller. The switch moves, under instruction from the timing controller, to a position that allows identical pixel data extracted from the signal to be transmitted simultaneously to the first SPC and the second SPC.

### BACKGROUND

Many virtual reality (VR) applications, including gaming, engineering, and aviation applications, use head mounted displays (HMDs), i.e., display devices that are worn on viewers' heads. A stereo HMD may include two separate display regions positioned in proximity to each other, e.g., a first display region to display images to a viewer's left eye and a second display region to display images to the viewer's right eye. When the stereoscopic image is viewed, it creates the perception that the eyes are viewing a three-dimensional scene.

Pixel data that controls the images to be displayed in the first and second display regions may be obtained from a remote graphics controller. The remote graphics controller sends information for display in a plurality of packets, where each packet includes display data (e.g., red, green, and blue display levels) for one pixel of the display device.

### BRIEF DESCRIPTION OF THE DRAWINGS

FIG. 1 depicts a high-level block diagram of an example display device of the present disclosure;

FIG. 2 illustrates an example signal that may be sent to a display device by a remote graphics controller;

FIG. 3 is a flow diagram illustrating an example method for rendering an image on a display device; and

FIG. 4 illustrates an example of an apparatus.

### DETAILED DESCRIPTION

The present disclosure broadly describes an apparatus, method, and non-transitory computer-readable medium for using switches in stereo display devices to transmit identical pixel data to first and second display regions of the stereo display devices. As discussed above, a stereo head mounted display (HMD) may include two separate display regions positioned in proximity to each other, e.g., a first display region to display images to a viewer's left eye and a second display region to display images to the viewer's right eye. When viewed simultaneously, the images displayed to the left eye and right eye form a three-dimensional image.

Pixel data that controls the images to be displayed in the first and second display regions may be obtained from a remote graphics controller. The remote graphics controller sends information for display in a plurality of packets, where each packet includes display data (e.g., red, green, and blue display levels) for one pixel of the display device. Each packet is transmitted over a link (e.g., a wired cable or wireless network connection) between the remote graphics controller and the display device (e.g., the HMD). The amount of link bandwidth consumed by the transmission of the packets is a function of the pixel count, the color depth, and the frame rate of the pixel data. As an example, the bandwidth consumed by transmitting pixel data to an HMD may be approximately twenty gigabits per second. As the amount of link bandwidth consumed approaches the total available link bandwidth, transmission of display data between the remote graphics controller and the display device may be slowed, resulting in a reduction in image fidelity.

Examples of the present disclosure reduce the link bandwidth consumed when transmitting pixel data from a remote graphics controller to a stereo display device by enabling a “two-dimensional mode” that allows the left and right images (or portions of the left and right images) of the stereo display device to be rendered simultaneously from a single set of pixel data. Within the context of the present invention, “simultaneous” refers to a display operation in which a left image and a right image can be viewed at the same time. The images may or may not be displayed precisely at the same time, depending on link latency. In some cases, the difference in time between the display of the left image and the display of the right image is less than the time that elapses between frame changes (e.g., the time period corresponding to inverting the frame rate)

For instance, if the object of the viewer's focus is far away, the same image may be rendered by both the left and right regions of the display without visibly affecting the depth of the steroscopic image perceived by the viewer. In one example, the display device includes a timing controller that is configured to detect an indicator that indicates when the pixel data contained in a signal is to be rendered in accordance with the two-dimensional mode. The timing controller may, in response to the detection of the indicator, control the position of a switch that passes the pixel data to the serial-to-parallel converters that parallelize the pixel data for display in the left and right display regions. When the switch is positioned to pass identical pixel data to both serial-to-parallel converters simultaneously, this causes the left and right display regions to simultaneously render the same image. As such, the pixel data may be sent by the graphics controller once for both display regions, as opposed to sending individual pixel data for each of the display regions. This may reduce the image fidelity in areas of the display regions where pixel data is shared; however, the reduction in fidelity may be limited to regions of the display image where the viewer's perception of depth is not likely to be noticeably affected.

As such, examples of the present disclosure may be well suited to stereo display applications that make use of foveated rendering techniques (i.e., techniques that track a viewer's gaze and render portions of an image outside the center of the gaze at a lower fidelity to reduce power consumption and improve performance). For instance, examples of the present disclosure may be used to render images on head mounted displays. Examples of the present disclosure may also be used to render images on non-VR stereo displays as well.

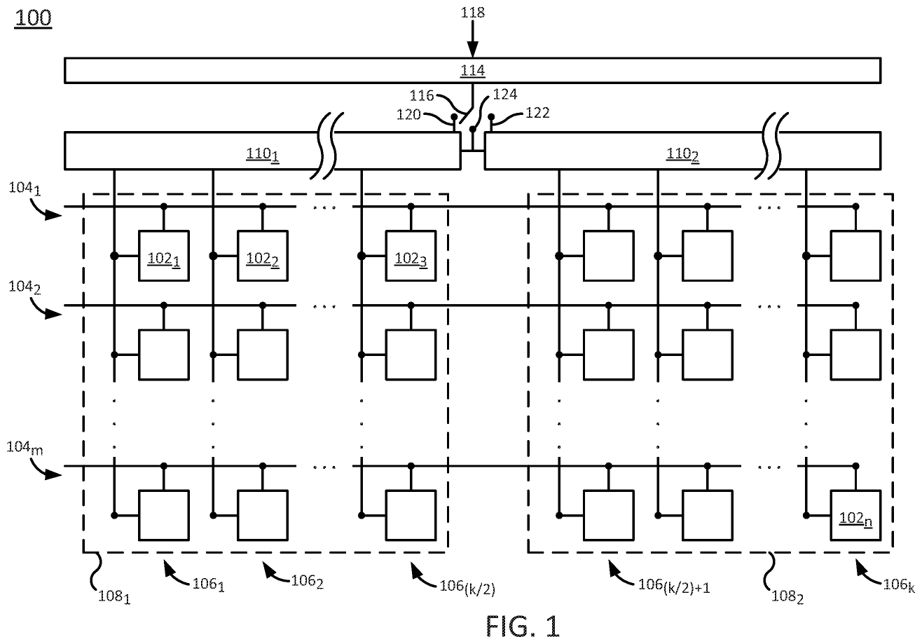

FIG. 1 depicts a high-level block diagram of an example display device 100 of the present disclosure. In one example, the display device 100 includes a plurality of pixels 102₁-102ₙ (hereinafter individually referred to as a “pixel 102” or collectively referred to as “pixels 102”). The plurality of pixels 102 includes at least a first pixel 102₁ and a second pixel 102₂. In one example, each pixel 102 is controllable to display a different color, where the color displayed by a pixel 102 may be represented by a plurality of component intensities, such as red, green, and blue (RGB) component intensities or cyan, magenta, yellow, and black (CMYK) component intensities.

The plurality of pixels is arranged in a plurality of rows 104₁-104ₘ (hereinafter individually referred to as a “row 104” or collectively referred to as “rows 104”) and a plurality of columns 106₁-106ₖ (hereinafter individually referred to as a “column 106” or collectively referred to as “columns 106”). The plurality of rows 104 includes at least a first row 104₁ and a second row 104₂, while the plurality of columns 106 includes at least a first column 106₁ and a second column 106₂. The number of rows 104 may or may not be equal to the number of columns 106, depending on the display device. For example, for an HMD, the display typically includes fewer rows than columns. In one example, one pixel of the plurality of pixels resides at each intersection of a row 104 and column 106.

Each row 104 is controlled by a respective row driver (not shown) that drives a command that causes the pixels 102 residing in the row 104 to render pixel data extracted from a signal 118 from a graphics controller (e.g., a local graphics controller or a remote graphics controller coupled to the display device via a wires or wireless network link). Similarly, each column 106 is controlled by a respective column driver (not shown) that transmits the pixel data for a pixel 102 in the given column 106 to the pixel 102 when the row 104 in which the pixel 102 resides is being rendered. In one example, the plurality of column drivers comprises a plurality of digital-to-analog converters (DACs).

In one example, the plurality of pixels 102 is further divided into a first display region 108₁ and a second display region 108₂ (hereinafter individually referred to as a “display region 108” or collectively referred to as “display regions 108”). In a first mode of operation (e.g., a “three-dimensional” mode), the first display region 108₁ and the second display region 108₂ may be used to display two separate images (e.g., two-dimensional images) that, when viewed simultaneously by a viewer, form a single three-dimensional image. In a second mode of operation (e.g., a “two-dimensional” mode), the first display region 108₁ and the second display region 108₂ may be used to display the same image (e.g., the same two-dimensional image) such that, when that same image is viewed simultaneously by the left eye and the right eye, a single image is formed that may still be perceived three-dimensional. Thus, the first display region 108₁ may comprise a left eye display region, while the second display region 108₂ may comprise a right eye display region.

As illustrated, each display region 108 may comprise a separate subset of the plurality of pixels 102. For instance, a first plurality of the pixels 102 may be arranged to form the first display region 108₁, while a second plurality of the pixels 102 may be arranged to form the second display region 108₂. In one example, the rows 104 of pixels 102 may be shared by both display regions 108, while the columns 106 of pixels 102 may belong to either the first display region 108₁ or the second display regions 108₂. Each display region 108 may further be paired with separate optics (not shown), e.g., for the left eye or the right eye. Although the example illustrated in FIG. 1 shows an equal number of rows 104 and columns 106 in the display regions 108, it should be noted that the display regions 108 may contain different numbers of rows 104 and/or columns 106.

The display device 100 further includes a first serial-to-parallel converter (SPC) 110₁ coupled to the first display region 108₁ (e.g., coupled to the column drivers of the first display region 108₁) and a second SPC 110₂ coupled to the second display region 108₂ (e.g., coupled to the column drivers of the second display region 108₂) The first SPC 110₁ and the second SPC 110₂ are hereinafter individually referred to as an “SPC 110” or collectively referred to as “SPCs 110.” The SPCs 110 are configured to extract serial pixel data from the signal 118 sent by the remote graphics controller and to digitally convert the serial pixel data to parallelized pixel data, which is subsequently converted by the column drivers to analog values for each column 106 of the display device 100.

In one example, the display device 100 further includes a timing controller 114 and a switch 116. The timing controller 114 is configured to receive the signal 118 from the remote graphics controller and to detect an indicator in the signal 118 that indicates whether corresponding serial pixel data is “two-dimensional” data or “three-dimensional” data. In the case where the serial pixel data is three-dimensional pixel data, this indicates that rendering of the pixel data is to be performed according to conventional techniques for rendering stereo images. In one example, this means that the serial pixel data is parallelized and converted to analog values for one display region 108 of the display device 100 (or for one eye of the viewer) at a time. For instance, a first image may be rendered in the first display region 108₁ using the serial pixel data, and then a second image may be rendered in the second display region 108₂ by horizontally adjusting the “camera” position in software to simulate the view of the first image from the second display region 108₂.

By contrast, when the serial pixel data is two-dimensional pixel data, this indicates that rendering of the pixel data is to be performed simultaneously for both display regions 108 of the display device 100 (or for both eyes of the viewer). For instance, identical images may be rendered, simultaneously, in both the first display region 108₁ and the second display region 108₂.

The timing controller 114 controls the position of the switch 116 based on whether the serial pixel data contained in the signal 118 is two-dimensional or three-dimensional pixel data. In one example, a first position 120 of the switch 116 allows the timing controller 114 to send a first signal to the first SPC 110₁ to render a first image in the first display region 108₁ (using the serial pixel data), without sending the first signal to the second SPC 110₂. Similarly, a second position 122 of the switch 116 allows the timing controller 114 to send a second signal to the second SPC 110₂ to render a second image, which may be an adjusted version of the first image, in the second display region 108₂ (using the serial pixel data), without sending the second signal to the first SPC 110₁. By sending the second signal immediately subsequent to the first signal, three-dimensional pixel data may be rendered as an image (e.g., in accordance with the techniques discussed above).

A third position 124 of the switch 116 allows the switch 116 to send a single signal to the first SPC 110₁ and the second SPC 110₂ to simultaneously to render the same image using the serial pixel data. By sending the signal simultaneously to the first SPC 110₁ and the second SPC 110₂, two-dimensional pixel data may be rendered by both display regions 108 while minimizing the link bandwidth used to transmit the pixel data.

The serial pixel data may be extracted from the signal 118 by the timing controller 114 and send on to the SPCs 110, or the signal 118 may be sent to the SPCs 110 as well as to the timing controller 114. In the latter case, the SPCs 110 may extract the serial pixel data from the signal 118.

The display device 100 has been simplified for ease of illustration. Those skilled in the art will appreciate that the display device 100 may include addition components, such as drivers, transistors, and capacitors, which are not illustrated.

In operation, a two dimensional image may be rendered on the display device 100 beginning with a “vertical sync.” Pixel data (e.g., component intensities for pixels) is transferred simultaneously to the first (e.g., top most, left most) pixel 102₁ of the first display region 108₁, which is located at the intersection of the first row 104₁ and the first column 106₁, and to the first (e.g., top most, left most) pixel 102 of the second display region 108₂, which is located at the intersection of the first row 104₁ and the (k/2)+1^{th} column 106_{(k/2)+1}. Pixel data transfer continues along the first row 104₁ (e.g., moving left to right) to transfer pixel data to the remaining pixels 102 in the first row 104₁ in both the first display region 108₁ and the second display region 108₂, until the pixel at the intersection of the first row 104₁ and the last column 106_{k/2} of the first display region 108₁ is reached and the pixel at the intersection of the first row 104₁ and the last column 106ₖ of the second display region 108₂ is reached.

A “horizontal sync” command may then reset the column to the first column 106₁ of the first display region 108₁ and the first column 106_{(k/2)+1} of the second display region 108₂ and increment the row to the next row (i.e., the second row 104₂). Pixel data transfer may resume with the first (e.g., left most) pixels of the second row 104₂, which are located at the intersection of the second row 104₂ and the first column 106₁ for the first display region 108₁ and at the intersection of the second row 104₂ and the k/2+1^{th} column for the second display region 108₂. Pixel data transfer continues along the second row 1042 (e.g., moving left to right) to transfer pixel data to the remaining pixels 102 in the second row 104₂, until the pixels at the intersection of the second row 104₂ and the k/2^{th} column 106_{k/2} and at the intersection of the second row 104₂ and the last column 106ₖ are reached. Pixel data transfer may continue in this manner, row-by-row, until pixel data is transferred to the final (e.g., bottom most, right most) pixels 102ₙ of the display regions 108, which are located at the intersection of the last row 104ₘ and the k/2^{th} column 106_{k/2} in the first display region 108₁ and the intersection of the last row 104ₘ and the last column 106ₖ in the second display region 108₂. Thus, identical pixel data may be transferred, pixel-by-pixel, to the first and second display regions 108₁ and 108₂ simultaneously.

In some examples, e.g., particularly when the display device 100 is operating in “two-dimensional mode,” the physical association between the columns of the first and second display regions 108 may not be absolutely tied together (e.g., such that the pixel data written to the first column 106₁ of the first display region 108₁ corresponds to the pixel data written to the first column 106_{(k/2)+1} of the second display region 108₂, and so on). For instance, the pixel data transferred to the first column 106_{(k/2)+1} of the second display region 108₂ may be shared with a column starting anywhere between the first column 106₁ and the last column 106_{k/2} of the first display region 108₁. The reason for this is that the viewing angle of the entire image displayed by the display device 100 may be wider than the amount of the image that is viewed by each eye. Put another way, there is naturally some offset between the viewing areas of the left eye and the right eye in humans (e.g., there are areas that are visible to the left eye but not the right eye, and vice versa), and the brain combines these viewing areas to create a complete scene that compensates for the offset. The positioning of the offset would normally be a function of the interpupillary distance between the left and right eyes.

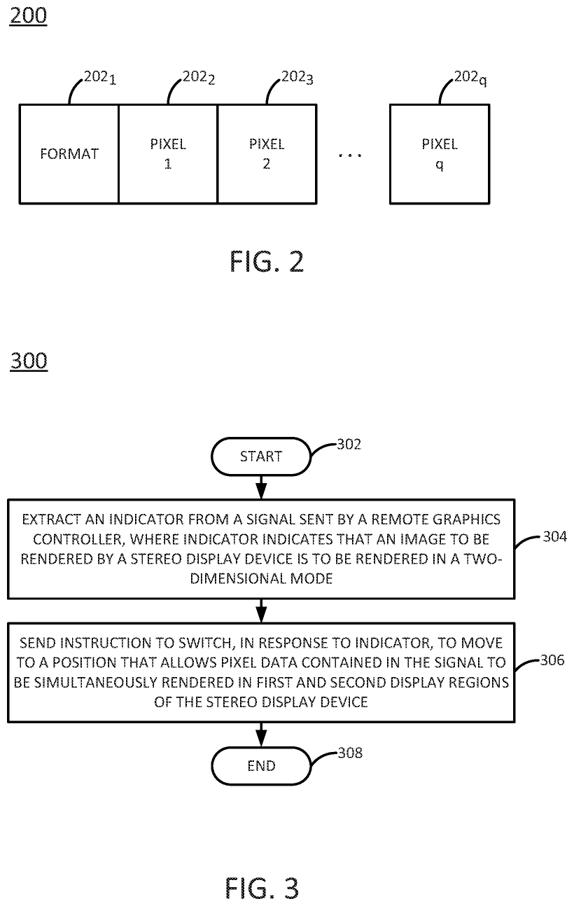

For instance, for an image rendered on in the display device 100 of FIG. 1, the right-most column 106_{k/2} of the first display region 108₁ may correspond to a column that is located approximately seventy-five percent across (i.e., moving left to right) the second display region 108₂, while the left-most column 106_{(k/2)+1} of the second display region 108₂ may correspond to a column that is approximately twenty-five percent across (i.e., moving from left to right) the first display region 108₁. FIG. 2 illustrates an example signal 200 that may be sent to a display device by a remote graphics controller. The signal 200 may be similar to the signal 118 illustrated in FIG. 1. As illustrated in FIG. 2, the signal 200 may include a plurality of packets 202₁-202_{q} (hereinafter individually referred to as a “packet 202” or collectively referred to as “packets 202”). The plurality of packets 202 includes at least a first packet 202₁ and a second packet 202₂.

In the example shown in FIG. 2, the first packet 202₁ of the signal 200 includes an indicator that identifies the format of the following packets as being either two-dimensional or three-dimensional. For instance, the indicator may include text, images, or any combination thereof that allows the timing controller 114 to differentiate between modes (e.g., “two-dimensional” versus “three-dimensional,” “2D” versus “3D,” “0” versus “1” where 0 corresponds to two-dimensional and 1 corresponds to three-dimensional, or any other type of indicator). In another example, the indicator may be the setting or status of a bit in the “stereo video attribute” data field of the signal (e.g., where the signal conforms to the format used by the DisplayPort standard for digital display technology.

Thus, this indicator controls whether the serial pixel data included in the subsequent packet(s) will be rendered in sequence by the individual display regions of the display device (e.g., rendered first by a first display region, and then rendered subsequently by a second display region, possibly with some adjustment for camera position) or rendered simultaneously by the individual display regions (e.g., as two identical images). The packets 202 following the first packet 202₁ include the pixel data for individual pixels of the display regions of the display device.

In another example, the indicator may be contained the headers of packets which contain the pixel data in their payloads, rather than contained as a payload in a dedicated packet.

Thus, the fidelity of the three dimensional image that results from rendering the same two-dimensional image simultaneously in multiple display regions may be lower compared to the fidelity of three dimensional images that result from rendering separate images in each of the display regions. In this way, the fidelity of different images may be varied.

Additionally, the fidelity of different regions in a single image may be varied in a manner that supports foveated rendering of an image. For instance, pixels that correspond to regions of a three-dimensional image where depth is less easily perceived (e.g., background, periphery, regions near the viewer's nose, and other regions where there is little or no overlap between the views of the left and right eyes) can be rendered according to the two-dimensional technique described above (e.g., rendering the same pixel data simultaneously in multiple display regions), while other regions of the three dimensional image (e.g., near the center of the viewer's gaze, regions of image detail, etc.) may be rendered according to conventional three-dimensional techniques (e.g., rendering different pixel data sequentially in one display region, then in the next display region). The signal that is sent by the graphics controller may account for the variation in format, for instance by inserting an indicator in the signal each time the format of the following packets switches from two-dimensional to three-dimensional, or vice versa.

Moreover, by sending a single set of pixel data that can be shared, without adjustment, by all display regions of stereo display device, as opposed to sending individual sets of pixel data for each of the display regions, the amount of data sent over the link between the image source (e.g., graphics controller) and the display device may be reduced. As such, valuable link bandwidth may be conserved, allowing for improved image fidelity and faster image rendering.

In addition, because there may be less pixel data to transmit over the link, the sending of the pixel data may be delayed. Delaying sending of the pixel data may allow for more accurate detection of the viewer's head position, which in turn may help to better tailor the image to be displayed to the user (e.g., to determine which regions of the image should be displayed at a higher fidelity, etc.).

Examples of the present disclosure may also allow VR hardware such as HMDs, which have traditionally been used to display three-dimensional images, to be used to display two-dimensional data. For instance, a viewer could use an HMD to read an electronic book.

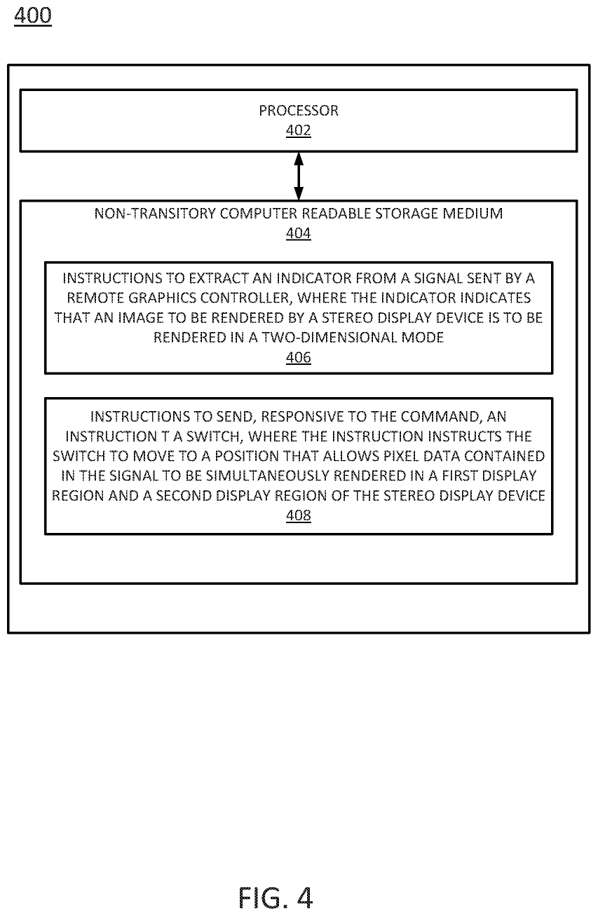

FIG. 3 is a flow diagram illustrating an example method 300 for rendering an image on a display device. The method 300 may be performed, for instance, by the timing controller 114 of the display device 100 of FIG. 1, or by a device as illustrated in FIG. 4. As such, reference may be made in the discussion of the method 300 to various components of the display device 100. Such references are made for the sake of example, however, and do not limit the means by which the method 300 may be implemented.

The method 300 begins in block 302. In block 304, an indicator is extracted from a signal sent by a remote graphics controller. The signal may be transmitted from the remote graphics controller via a wired cable and/or a wireless network connection. In one example, the indicator indicates that an image to be rendered by a stereo display device is to be rendered in accordance with a two-dimensional mode.

For instance, referring back to FIG. 2, the first packet 202₁ of the signal 200 includes a format indicator. This indicator may indicate whether pixel data contained in the following packets 202 is to be rendered in a two-dimensional mode or a three-dimensional mode by the stereo display device. In the case of block 304, the indicator may read “two-dimensional,” or may contain any other text, image, or combination thereof that indicates to the timing controller that two-dimensional mode is to be used.

Referring back to FIG. 3, in block 306 and responsive to the indicator extracted in block 304, an instruction is sent to a switch that is coupled to first and second display regions of the stereo display device (e.g., to the SPCs that transmit parallelized pixel data to the display regions' column drivers). The instruction instructs the switch to move to a position that allows the pixel data in subsequent packets of the signal to be simultaneously rendered in the first and second display regions. For instance, the instruction may instruct the switch 116 of FIG. 1 to move to the third position 124.

The method 300 ends in block 308. As discussed above, simultaneous viewing of the first display region and the second display region, subsequent to rendering of the appropriate pixel data according to the method 300, may create a perception that a single three-dimensional image is being viewed.

It should be noted that although not explicitly specified, some of the blocks, functions, or operations of the method 300 described above may include storing, displaying and/or outputting for a particular application. In other words, any data, records, fields, and/or intermediate results discussed in the method 300 can be stored, displayed, and/or outputted to another device depending on the particular application. Furthermore, blocks, functions, or operations in FIG. 3 that recite a determining operation, or involve a decision, do not necessarily imply that both branches of the determining operation are practiced.

FIG. 4 illustrates an example of an apparatus 400. In one example, the apparatus 400 may be the controller 118 of FIG. 1. In one example, the apparatus 400 may include a processor 402 and a non-transitory machine readable storage medium 404. The non-transitory machine readable storage medium 404 may include instructions 406 and 408 that, when executed by the processor 402, cause the processor 402 to perform various functions.

The instructions 406 may include instructions to extract an indicator from a signal sent by a remote graphics controller. The signal may be transmitted from the remote graphics controller via a wired cable and/or a wireless network connection. In one example, the indicator indicates that an image to be rendered by a stereo display device is to be rendered in accordance with a two-dimensional mode. The instructions 408 may include instructions to send an instruction to a switch that is coupled to first and second display regions of the stereo display device (e.g., to the SPCs that transmit pixel data to the display regions' column drivers). The instruction instructs the switch to move to a position that allows the pixel data in subsequent packets of the signal to be simultaneously rendered in the first and second display regions. For instance, the instruction may instruct the switch 116 of FIG. 1 to move to the third position 124.

It will be appreciated that variants of the above-disclosed and other features and functions, or alternatives thereof, may be combined into many other different systems or applications. Various presently unforeseen or unanticipated alternatives, modifications, or variations therein may be subsequently made which are also intended to be encompassed by the following claims.

What is claimed is:

1. A display device, comprising:
a first plurality of pixels arranged in a first display region to display a first image to be viewed by a left eye of a user;
a second plurality of pixels arranged in a second display region to display a second image to be viewed by a right eye of a user;
a first serial-to-parallel converter coupled to the first display region;
a second serial-to-parallel converter coupled to the second display region;
a timing controller to detect an indicator in a signal received from a graphics controller; and
a switch to move, under instruction from the timing controller, to a position that allows identical pixel data extracted from the signal to be transmitted to the first serial-to-parallel converter and the second serial-to-parallel converter.

2. The display device of claim 1, wherein the display device is a head mounted display.

3. The display device of claim 1, wherein the signal comprises:
a first packet containing the indicator; and
a second packet following the first packet and containing the identical pixel data.

4. The display device of claim 1, wherein another position of the switch allows other pixel data extracted from the signal to be transmitted the first serial-to-parallel converter without being transmitted to the second serial-to-parallel converter.

5. The display device of claim 1, wherein another position of the switch allows other pixel data extracted from the signal to be transmitted the second serial-to-parallel converter without being transmitted to the first serial-to-parallel converter.

6. A method, comprising:
extracting, by a controller of a stereo display device, an indicator from a signal sent by a remote graphics controller; and
sending, responsive to the indicator, an instruction to a switch, where the instruction instructs the switch to move to a position that allows pixel data contained in the signal to be rendered in a first display region and a second display region of the stereo display device.

7. The method of claim 6, wherein the stereo display device is a head mounted display.

8. The method of claim 6, wherein rendering the pixel data in the first display region and the second display region causes the first display region and the second display region to simultaneously display identical images.

9. The method of claim 6, wherein other pixel data contained in the signal is rendered in the first display region without being rendered in the second display region.

10. The method of claim 6, wherein the signal comprises:
a first packet containing the indicator; and
a second packet following the first packet and containing the pixel data.

11. A non-transitory machine-readable storage medium encoded with instructions executable by a processor, the non-transitory machine-readable storage medium comprising:
instructions to extract an indicator from a signal sent by a remote graphics controller; and
instructions to send, responsive to the indicator, an instruction to a switch, where the instruction instructs the switch to move to a position that allows pixel data contained in the signal to be rendered in a first display region and a second display region of a stereo display device,
wherein simultaneous viewing of the first display region and the second display region, subsequent to rendering of the pixel data, creates a perception that a single three-dimensional image is being viewed.

12. The non-transitory machine-readable storage medium of claim 11, wherein the stereo display device is a head mounted display.

13. The non-transitory machine-readable storage medium of claim 11, wherein rendering the pixel data in the first display region and the second display region causes the first display region and the second display region to simultaneously display identical images.

14. The non-transitory machine-readable storage medium of claim 11, wherein other pixel data contained in the signal is rendered in the first display region without being rendered in the second display region.

15. The non-transitory machine-readable storage medium of claim 11, wherein the signal comprises:
a first packet containing the indicator; and
a second packet following the first packet and containing the pixel data.
